(19) United States
(12) Patent Application Publication
(10) Pub. No.: US 2014/0058968 A1
(43) Pub. Date: Feb. 27, 2014

(54) SYSTEM, METHOD, AND COMPUTER PROGRAM PRODUCT FOR AGGREGATING AND DISTRIBUTING CHARITABLE CONTRIBUTIONS

(71) Applicant: Richard A. Booth, Baltimore, MD (US)

(72) Inventor: Richard A. Booth, Baltimore, MD (US)

(21) Appl. No.: 13/972,826

(22) Filed: Aug. 21, 2013

Related U.S. Application Data
(60) Provisional application No. 61/742,860, filed on Aug. 21, 2012.

(51) Int. Cl. G06Q 30/02

(52) U.S. Cl. CPC G06Q 30/0279
USPC 705/329; 705/26.3

(57) ABSTRACT

The present invention is a method for aggregating individual charitable contributions to fund public-space improvement projects as defined by consensus of the contributors and approved by a designated government officer, and by which service providers may submit competing bids for completing such projects, all by means of a charitable foundation formed for purposes of funding such projects and a website incorporating functions that address the formation and performance of contracts relating to such projects.

### CROSS REFERENCE TO RELATED APPLICATION

This application claims priority to U.S. Provisional Application No. 61/742,860 filed Aug. 21, 2012, which is incorporated by reference in its entirety.

### FIELD OF INVENTION

The present invention is directed in part to a method or system of funding public space improvement projects as defined by one or a plurality of contributors and combined with a method or system by which service providers may bid on doing the work as so defined. In some embodiments the invention is further combined with a system through which a designated government official may approve the project for purposes of gaining access to public spaces and to avoid duplication of effort with existing government projects as well as to resolve disputes as to satisfactory completion.

### BACKGROUND

Existing crowd funding systems and methods permit entrepreneurs, artists, and others to seek funding for projects they propose to complete primarily for their own benefit. The present invention relates to a crowd-funding method or system for aggregating individual tax-deductible contributions to fund public-space improvement projects (PIPs) proposed and defined by the contributors and approved by a designated government officer. In some embodiments, service providers may qualify to submit competing bids for completing such projects, all by means of a charitable foundation formed for purposes of funding such projects and a website incorporating functions that address the formation and performance of contracts relating to such projects.

### SUMMARY OF THE INVENTION

In some embodiments, the invention relates to a method or system for aggregating individual charitable contributions for purposes of funding public-space improvement projects (PIPs) as defined by one or a plurality of contributors. In some embodiments, the invention comprises the formation of a charitable foundation for the purpose of funding such projects. In some embodiments, the invention relates to a computer-implemented method of hosting a web-based auction or forum by which (1) a proponent-contributor (PC) may submit or post a description of a proposed PIP and, optionally, deposit funds to a deposit account designated to form the charitable foundation (as previously contributed to the foundation by the PC) when one or a plurality of distribution criteria are met. In some embodiments, the invention further comprises the deposit of other depositor visitors visitor contributors (VCs)—to the website who commit deposit funds to a client account or deposit account designated for the charitable foundation to augment funds committed to the PIP. In some embodiments, the invention further comprises bidding by registered service providers (RSPs) on the PIP by posting a price and other terms according to which the RSP will complete the PIP. In some embodiments, at least one or a plurality of balances of funds, or contributions, may not be withdrawn prior to a specified withdrawal date. In some embodiments, the one or plurality of distribution criteria comprise a specificed withdrawal date before which none of the contributions may be withdrawn or distributed. In some embodiments the method relates to forming a binding contract to complete the PIP between an individual, person or entity and the RSP when the amount of funds deposited is equal to the amount of funds identified in the RSP bid to complete or partially perform one or a plurality of PIPs. In some embodiments the method relates to forming a binding contract to complete the PIP between an individual, person or entity and the RSP when the project has been approved by a designated government official (DGO). In some embodiments, the RSP is paid the agreed amount upon completion of the PIP and approval by the PC without objection from VCs. In some embodiments, the PIPs may be modified according to various rules that may trigger withdrawal rights by VCs. In some embodiments, the PIPs may also be proposed by RSPs who may also contribute goods or services or combinations thereof in connection with at least partial performance of the PIP. In some embodiments, the invention relates to a system, computer program product or method comprising: a contributor qualifying for and receiving a tax deduction after depositing a balance of funds to a client account or an aggregated deposit account.

In some other embodiments, the invention relates to a method or system for similar improvements to private spaces that impinge on public view while assuring a charitable purpose through the involvement of a designated government official.

In still other embodiments, the invention relates to a method or system for aggregating seed capital or a balance of funds for private, for-profit businesses formed to provide a public service again while assuring a charitable purpose through the involvement of a designated government official. In still other embodiments, the invention relates to a method or system for aggregating seed capital or a balance of funds for non-profit businesses formed to provide a public service again while assuring a charitable purpose through the involvement of a designated government official.

### BRIEF DESCRIPTION OF DRAWINGS

FIG. 1 depicts a flow chart that details how the method might work in some embodiments.

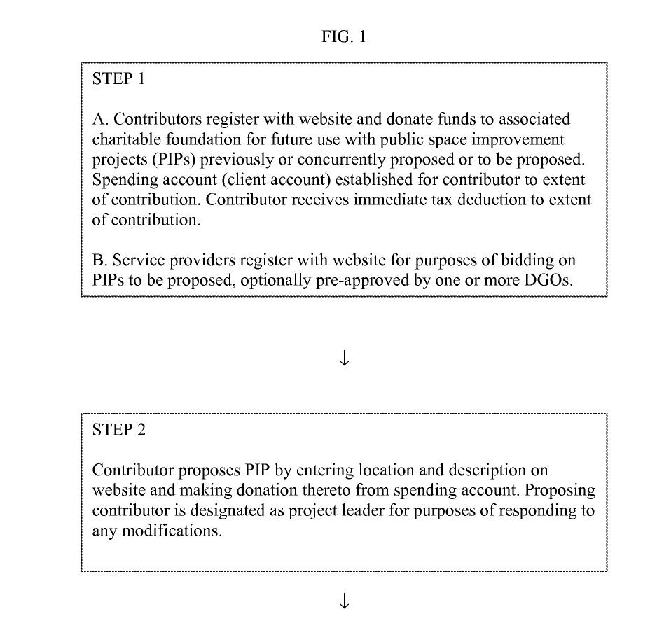

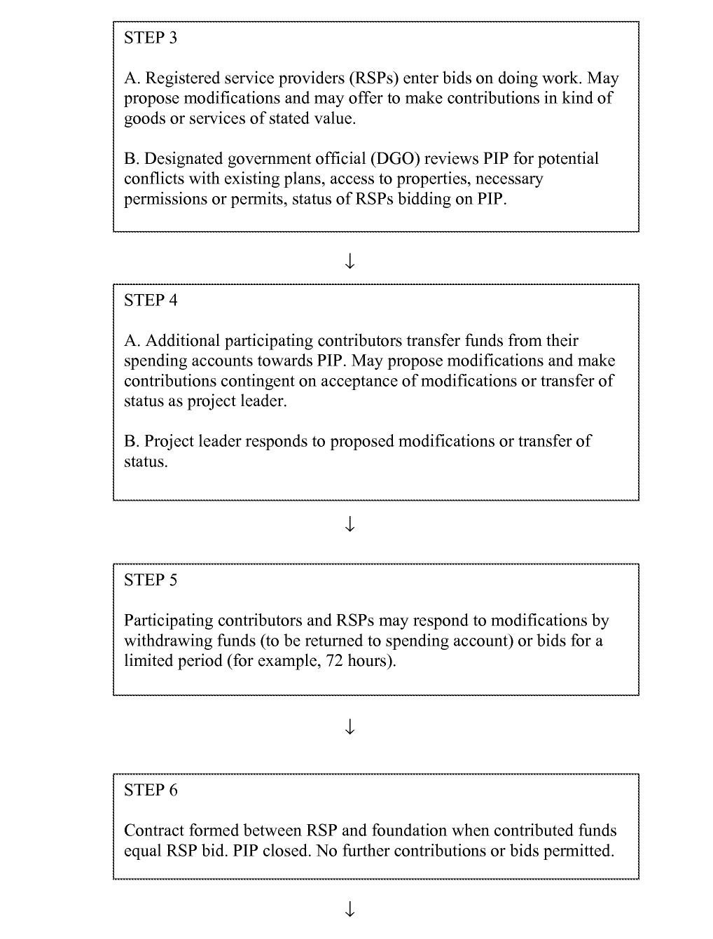

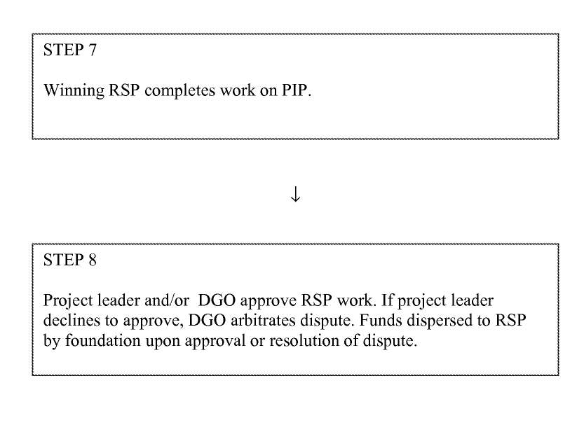

### DETAILED DESCRIPTION OF THE INVENTION

As used herein the following terms have the following meanings: “bid” means any proposal submitted by a service provider that details a price to be paid for services and/or products to be used to at least partially perform one or a plurality of PIPs. In some embodiments, the bid comprises a total price associated with completing or at least partially completing one or a plurality of PIPs.

“registered service provider” (RSP) means any person, individual, group or entity that supplies a service or product or funds or in kind services in connection with performing work toward the completion of a public space improvement project. In some embodiments, the service provider is registered with the designated government official responsible for issuing licenses or permits to perform types of work within the geographic area comprising one or plurality of public spaces.

“public-space improvement project” (PIP) means a proposal that has been posted for purposes of soliciting bids that may qualify for funding depending on approval by the DGO.

“aggregated deposit account” means funds that have been allocated from one or more client accounts for purposes of funding a PIP, whether or not the PIP has been fully or partially funded and whether or not the PIP has been approved by the DGO and whether or not any RSP has submitted a bid on the PIP.

“client account” means an account that holds funds that have been contributed for purposes of future designation. IN some embodiments, the funds held are designated by a contributor for use in connection with a PIP and that are held under the name of a contributor for purposes of such future designation.

“individual” means any person, entity, or group of people or entities.

“distribution criteria” means any criterion or plurality of criteria or condition provided by an individual that determines if and/or when funds for a PIP or plurality of PIPs are aggregated or allocated to an aggregated deposit account, or distributed to one or a plurality of service providers to at least partially perform one or a plurality of PIPs. In some embodiments, the distribution criteria are on any of the disclosed systems provided herein or are provided to any of the disclosed system provided herein through a computer-based processor or through a computer-based storage medium. In some embodiments, the distribution criteria comprise a price (or proposed priced) to at least partially or fully perform one or a plurality of PIPs. In some embodiments, the distribution criteria comprise receiving authorization from a designated government official or officials to at least partially or fully perform one or a plurality of PIPs.

“designated government official” (DGO) means a government official authorized within a specified geographic area: to review PIPs for potential conflicts with existing plans, access to properties, necessary permissions or permits, or to approve registration of service providers for purposes of bidding on PIPs, and to resolve disputes as to completion of PIPs.

“depository institution(s)” means any bank or other similar financial institution in which client funds may be held (whether or not aggregated for purposes of funding a particular PIP).

“funds” is a currency of any nation-state in the natural world or an option to purchase or sell currency of any nation-state of the natural world. In some embodiments, funds is meant to refer to United States dollars or a value of foreign currency equivalent to United States dollars using the exchange rates published by relevant authorities. In some embodiments, the term “funds” may also apply to the value of goods or services that may be contributed or otherwise transferred or bartered in connection with funding a PIP whether or not the value of such goods or services has been determined or estimated.

“client account information” means any data or information from a person, group or entity that establishes an account. In some embodiments, the client account information means any identifying name or number associated with the person, group, or entity and it corresponding account whether or not the account has been funded. In some embodiments, the client account information comprises a number corresponding to an account identification number. In some embodiments, the client account information comprises a number corresponding to an account identification number and any name of an individual, group, or entity.

“allocation” and “allocating” means the process by which funds are transferred from a client account to an aggregated deposit account.

“distribution” and “distributing” means the transfer of funds. in some embodiments, the tmers mean transferring funds from one or a plurality of client account to one or a plurality of aggregated deposit accounts. in some embodiments, the terms mean transferring funds from one or a plurality of client accounts or one or a plurality of aggregated deposit accounts to one or more service providers or RSPs upon the completion or partial completion of a PIP. in some embodiments, the terms mean transferring funds from one or a plurality of client accounts or one or a plurality of aggregated deposit accounts to one or more service providers or RSPs upon the the satisfaction of the DGO and/or one or more client contributors.

The invention relates to a computer-implemented method of collecting and/or distributing charitable funds for at least partial performance of a PIP, the method comprising: in a system configured to host a webpage, the system comprising at least one processor and a memory, acquiring, by the at least one processor, a proposal for one or a plurality of public space improvement projects with one or a plurality of distribution criteria; setting, by the at least one processor, one or a plurality of distribution criteria; receiving, by the at least one processor, one or a plurality of bids to complete the one or plurality of PIPs; and accepting a bid from one or a plurality of service providers, by the at least one processor, that meets the one or plurality of distribution criteria. In some embodiments, the computer-implemented method further comprises at least one or combination of the following steps: (i) receiving funds from a first individual, group or entities or plurality of individuals, groups, or entities in a client account or deposit account designated to fund or partially fund one or a plurality of PIPs; (ii) forming a contract between or among: (a) one or a plurality service providers that submit a bid that meets the one or plurality of distribution criteria; and (b) one or a plurality of individuals that submit a proposal for one or a plurality of PIPs to at least partially perform the one or plurality of PIPs; receiving authorization from a designated government official for at least partial performance of the one or a plurality of PIPs; (iii) distributing the funds to the at least one service provider or the individual, group, or entity that proposed the one or plurality of PIPs for at least partial performance of the one or plurality of PIPs after the one or plurality of distribution criteria have been met and/or receiving authorization from the designated government official; (iv) transferring funds from one or a plurality client accounts to an aggregated deposit account; and (v) designating the funds deposited in the one or plurality of client accounts for aggregation into the one or a plurality of aggregated deposit accounts after the one or plurality of distribution criteria have been met and/or receiving authorization from the designated government official. In some embodiments, the one or set of distribution criteria are modified prior to receiving a bid that meets the one or plurality of distribution criteria by a service provider. In some embodiments, the one or set of distribution criteria are modified by an individual, group or entity, wherein the individual, group, or entity is not: (i) the individual group or entity that submitted one or a plurality of PIPs; or (ii) a service provider. In some embodiments, the one or set of distribution criteria are modified by an individual, group or entity that is a service provider. In some embodiments, the one or set of distribution criteria are modified by the individual group or entity that submitted one or a plurality of PIPs. In some embodiments, the method disclosed herein comprise modifying the one or plurality of distribution criteria prior to initiating an auction, at least partially performed through a website, for selection or identification of a service provider to at least partially perform one or a plurality of PIPs.

The present invention generally relates to a system, method and program product for collecting, aggregating and/or distributing funds In some embodiments, the invention generally relates to a system, method and program product for collecting, aggregating and/or distributing funds for performance of a public space improvement project (PIP).

The invention relates to a method of aggregating charitable funds for at least partial performance of a PIP.

The invention relates to a method of performing a PIP comprising one or a plurality of any of the steps disclosed herein in isolation or in combination.

The invention relates to a method of managing an electronic platform comprising one or a plurality of any of the steps disclosed herein in isolation or in combination.

The invention relates to a method of implementing public policy for at least partial performance of a PIP comprising one or a plurality of any of the steps disclosed herein in isolation or in combination.

The invention relates to a method of conducting an auction comprising one or a plurality of any of the steps disclosed herein in isolation or in combination.

The invention also relates to a method maintaining a balance of funds comprising one or a plurality of any of the steps disclosed herein in isolation or in combination. In some embodiments, the computer program product is a non-transitory computer program product.

In some embodiments, the aggregated account information for each of a plurality of the recipient depository institutions that are source institutions, may further comprise a balance of source funds from the respective recipient depository institution, where the source funds comprise funds where the respective recipient depository institution is a source of the funds into the deposit management program. In some embodiments, the source funds comprise funds of the respective institution held in one or more of the aggregated deposit accounts in the other recipient depository institutions in the program, and/or may be held in other investment vehicle accounts managed by the deposit management system for a program.

In some embodiments, the client account information in the one or more databases may comprise, for each of a plurality of the respective client accounts, one or more or all of: (a) a respective balance in the respective client account; (b) deposit/transfer and/or withdrawal/transfer data for the respective client account, which may include individual credit and debit data and/or nets of such credit and debit data for the client account, as previously described; and (c) a respective balance of funds from the respective client account held in each of one or more banks or other recipient depository institutions in the aggregated deposit accounts holding funds of the respective client account. in some embodiments, the client account represents funds of a client held in one or more of the aggregated deposit accounts held by the depository institutions in the program and any other investment vehicle accounts managed by the program.

In some embodiments, the one or more computers for the deposit management system may be operatively connected/accessible to computer-readable program code stored in memory, and may be capable of executing program code uploaded therefrom to configure the one or more computers into one or more special-purpose machines. The code, in some embodiments, may be comprised of programming modules or other software forms that implement functional components in the one or more computers. These modules or other software forms may be stored separately or in combination.

The one or more computers may be configured, in some embodiments, with program code to form an obtaining component. The obtaining component obtains a respective net transfer amount for the one or more sub-periods of time for each of one or more of the respective source institutions. The obtaining component, in some embodiments, may optionally obtain client account information for each of multiple of the client accounts, where the client account transaction information comprises credit information and/or debit information applied to or against a respective client account for one or more sub-periods of time and/or other transfer information.

As noted, the client account transaction information for each or multiple client accounts may comprise information regarding transactions applied to client accounts at source institutions, such as over a particular time period, such as a range of one or more hours, one or more days, one or more weeks, one or more months or the like. Such information may be in the form of detailed individual transactions, summary transactions (e.g., nets) or combinations thereof. The method described herein is different from other crowd-funding methods in several ways. The typical crowd-funding system permits service or product providers to post a description of the their project and to solicit contributions. With the method described here, the system, computer program product or method may comprise any one or combination of the following: (1) PIPs may be proposed by contributors who identify service providers to at least partially perform a PIP; (2) contributors may make contributions contingent on modifications to the PIP, (3) service providers may submit competing bids so as to complete the project at the lowest possible cost, (4) service providers may propose PIPs or submit bids contingent on modifications to existing PIPs, (5) contributors receive a charitable deduction for income tax purposes in connection with their contributions, (6) service providers who contribute goods and services to the project may also receive a charitable deduction for income tax purposes in connection with their contributions; and (7) a designated government official may monitor proposed PIPs for consistency with the master plan for the locality.

To be more specific, there are several features of the present invention that distinguish it from existing crowd-funding websites.

In some embodiments, PIPs must be authorized by a government and/or city official with the power to grant permission for work to be done on public property and to assure that it is done by responsible contractors. Thus, in some embodiments, the present invention requires that all proposals be routed to a designated government official (DGO). (One incidental benefit is that, in some embodiments, the method, system or computer program product can notify a DGO of the pendency of particular PIP and/or the DGO can identify potential duplication of efforts, such as where the city has already planned or funded a similar project.) In addition, in some embodiments, the DGO approves contractors or service providers before they will be permitted to enter bids.

In some embodiments, contributors receive an immediate tax deduction when they make a contribution to one or more deposit accounts, which is itself a charitable foundation under Section 501(c)(3) of the Internal Revenue Code). Contributions are held in an account under the name of the contributor (in some embodiments, a client account) until the funds are committed to a PIP. For example, a resident might contribute $1000 to the fund to be committed at the discretion of the contributor to PIPs as they arise. If the project fails to attract sufficient interest, funds would be returned to the contributor's client account for future use in connection with other projects to be proposed. But because of the tax benefits involved, funds cannot be returned to the contributor. If the sum of all of the designated funds for a particular PIP meets one or a plurality of funding criteria, the system, computer program product, or method disclosed herein may aggregate the funds from one or more client accounts to an aggregated deposit account, wherein the aggregated deposit account holds all designated funds for a particular PIP until a DGO approves of the at least partial performance of the PIP. In any of the disclosed embodiments, the method of aggregating funds can be run through one or more systems comprising at least one computer processor and, optionally on a single website. In some embodiments, the website is accessible only to registered users of the website.

It would also be possible to visit the website without already having set up an account and to make a one-time contribution to a PIP. But if the PIP does not ultimately get funded, the contribution would revert to an account in the name of the contributor for future use and would not be refunded in cash—again because of the associated tax benefits. Funds that remain dormant for five years (for example) might be dispensed by the trustees possibly as matching funds or directly to the city or other charities (depending on the precise terms of the governing documents of the foundation). Foundation expenses would be defrayed by interest on contributions.

The present invention also differs from existing crowd-funding websites in several other ways. Existing crowd-funding sites typically involve entrepreneurs who seek funds for their own artistic or business undertakings and offer some sort of token to contributors in return. In contrast, the present invention is more interactive and offers more substantial benefits in that, in some embodiments:
it permits residents to propose and entrepreneurs to bid on PIPs
it permits contributors to propose one or a plurality of modifications to PIPs
it facilitates competition among entrepreneurs who may offer to complete PIPs at lower cost
it permits entrepreneurs themselves to propose PIPs and to seek funding through the system
it encourages the formation of small businesses, the creation of new jobs, and the preservation of existing jobs by permitting existing businesses to utilize excess capacity
it provides tax incentives for residents to make contributions that give rise to charitable deductions under existing provisions of federal and state income tax law
it provides benefits that redound in part to contributors themselves through the improvement of public spaces
it cuts through red tape by permitting residents to fund PIPs outside the government appropriation process
it eliminates duplication of efforts and assists the city in choosing projects by adding private funds to projects that might otherwise be too costly
it eliminates waste by permitting residents to vote with their feet by funding the projects that add the most value to public spaces

To summarize, the present invention differs from other methods or systems of crowd funding in the following ways:

1. In some embodiments, the system or computer-implemented method permits a proposing contributor to define and control the details of a project with ultimate payment to the service provider contingent on satisfactory completion to be determined by the proposing contributor.

2. In some embodiments, the present invention permits multiple service providers to compete for a project both as to price and scope of work and/or details. In other words, other sites involve entrepreneurs (or artists or organizations) who seek funding for their ideas. The present invention differs in that the contributors may define the projects and invite service providers to bid on the work while preserving the opportunity for entrepreneurs themselves to propose the work as well.

3. In some embodiments, the present invention permits subsequent contributors and bidders to propose modifications to a project and to make contributions/bids that are contingent on acceptance thereof by the proposing contributor.

4. The present invention also permits contributors to transfer control of a project (such as where a subsequent contributor may want to make a contribution that is much larger than the proposing contributor). Thus, in some embodiments, the computer-implemented method comprises a step permitting the transfer of status as managing or lead contributor from the initial proposing contributor to another contributor or the DGO by agreement among the parties involved.

5. In some embodiments, the present invention results in funding projects only to the extent necessary to meet the lowest bid and returns excess funds to contributor accounts for redeployment or reallocation to other projects.

6. In some embodiments, the present invention comprises creation of a contract when contributors and service providers agree on price and details.

7. In some embodiments, the present invention comprises a designated government official (DGO) for purposes of gaining access to public spaces and to avoid duplication of effort with existing government projects as well as to resolve disputes as to satisfactory completion.

8. Unlike other platforms, in some embodiments, any of the disclosed methods herein comprise the step of incorporating a charitable foundation prior to distribution of the at least one balance of funds thereby generating .an immediate tax deduction for contributors at the time the contribution is made. In some embodiments, the charitable organization is formed even before any balance of funds are designated for one or a plurality of PIPs of wherein, if a project fails to fulfill one or plurality of distribution criteria, the funds are returned to a client account for redeployment (but not refund).

9. In some embodiments, the one or plurality of distribution criteria comprise the exchange of in kind service by one or both of the contributors and/or service providers.

In some embodiments, the invention relates to a method comprising accessing, using one or more computers, one or more electronic databases, stored on one or more computer-readable media, for assisting in carrying out one or more of the following operations, the one or more databases comprising: (i) one or a plurality of proposals for a public-space improvement projects (PIPs) and one or a plurality of aggregated deposit accounts, each aggregated deposit accounts corresponding to the one or a plurality of proposals for PIPs held in one or a plurality of recipient depository institutions, comprising a balance of funds held in each of the aggregated deposit accounts, wherein funds from one or a plurality of client accounts are aggregated with funds of other client accounts in the aggregated deposit accounts; and (ii) client account information for each of a plurality of deposit accounts comprising at least a respective balance of funds from the respective client account held in each of one or more recipient depository institutions in the aggregated deposit accounts holding funds of the respective client account;

proposing one or a plurality of public space improvement projects (PIPs);

submitting bids to complete the one or plurality of PIPs;

depositing funds into the one or a plurality of client accounts;

designating funds deposited in the one or plurality of client accounts for aggregation into one or a plurality of aggregated deposit accounts;

accepting a bid to form a contractual relationship between an individual or group that submits a bid to complete the one or a plurality of PIPs;

authorizing the completion of the one or plurality of PIPs;

allocating funds from one or a plurality of client accounts to one or plurality of aggregated deposit accounts, each aggregated deposit account designated for one or a plurality of PIPs;

distributing funds from the one or plurality of aggregated deposit accounts that correspond to the one or a plurality of proposals for PIPs after a designated government official (DGO) authorizes the completion of the one or plurality of PIPs.

In some embodiments, the invention relates to a method comprising accessing, using one or more computers, one or more electronic databases, stored on one or more computer-readable media, for assisting in carrying out one or more of the following operations:

proposing one or a plurality of public space improvement projects (PIPs);

submitting bids to complete the one or plurality of PIPs;

depositing funds into the one or a plurality of client accounts;

designating funds deposited in the one or plurality of client accounts for aggregation into one or a plurality of aggregated deposit accounts;

accepting a bid to form a contractual relationship between an individual or group that submits a bid to complete the one or a plurality of PIPs;

authorizing the completion of the one or plurality of PIPs;

allocating funds from one or a plurality of client accounts to one or plurality of aggregated deposit accounts, each aggregated deposit account designated for one or a plurality of PIPs;

distributing funds from the one or plurality of aggregated deposit accounts that correspond to the one or a plurality of proposals for PIPs after a designated government official (DGO) authorizes the completion of the one or plurality of PIPs.

In some embodiments, the one or set of distribution criteria are modified by an individual, group or entity, wherein the individual, group, or entity is not: (i) the individual group or entity that submitted one or a plurality of PIPs; or (ii) a service provider. In some embodiments, the one or plurality of distribution criteria are modified by an individual, group or entity that is a service provider. In some embodiments, the one or set of distribution criteria are modified by the individual, group, or entity that submitted one or a plurality of PIPs.

As used herein the term “plurality” means more than one. In some embodiments, plurality means 2, 3, 4, 5, 6, 7, 8, 9, 10 or more. In some embodiments, plurality means from about 3 to about 100. In some embodiments, plurality means from about 2 to about 100. In some embodiments, plurality means from about 10 to about 100. In some embodiments, plurality means from about 20 to about 100. In some embodiments, plurality means from about 2 to about 500.

In some embodiments, the computer-implemented method comprises conducting an online auction to identify a party, individual, group, or entity to become party to a contract to at least partially perform a one or a plurality of PIPs. In some embodiments, conducting an online auction means that, in some embodiments, any of the disclosed methods comprise: setting one or a plurality of distribution criteria; identifying a party responsible for control and/or management of the PIP and/or service provider (which, in some embodiments, is a contributor); acquiring a plurality of bids from a plurality of service providers for at least partial performance of a PIP wherein at least one of the bids meets one or a plurality of distribution criteria; and pairing a service provider bid meeting the most distribution criteria for at least partial performance of a PIP with the party responsible for paying the service provider. In some embodiments, the computer-implemented method comprises forming a contract between the service provider and the party responsible for control and/or management of the PIP and/or service provider either before, simultaneously with, or after a designated government official approves at least partial performance of the PIP. in some embodiments, the system, computer program product or methods comprise any of the formerly disclosed method of performing a web-based auction including one or a combination of the following disclosures: U.S. Pat. No. 8,473,353; U.S. Pat. Nos. 8,463,694; 8,401,921, 8,374,920; 8,364,554; 8,352,357; 8,219,484; 8,204,819, and 8,046,269, all of which are incorporated by reference in their entireties.

In some embodiments, the disclosure relates to a system including at least one processor and a computer readable memory, said computer readable memory having stored thereon program code for performing any of the embodiments or method components disclosed herein. comprising: means for storing data associated with a user of a user device; means for, responsive to performing the disclosed methods. In some embodiments, the disclosure relates to a system that comprises at least one processor, at least one program storage, such as memory, for storing program code executable on the processor, and one or more input/output devices and/or interfaces, such as data communication and/or peripheral devices and/or interfaces. In some embodiments, the user device and computer system or systems are communicably connected by a data communication network, such as a Local Area Network (LAN), the Internet, or the like, which may also be connected to a number of other client and/or server computer systems. The user device and client and/or server computer systems may further include appropriate operating system software.

In some embodiments, the invention relates to using one or more computers comprising at least one processor, and/or one or more electronic databases, stored on one or more computer-readable media that comprise: (i) one or a plurality of proposals for a public-space improvement projects (PIPs) and one or a plurality of aggregated deposit accounts, each aggregated deposit accounts corresponding to the one or a plurality of proposals for PIPs held in one or a plurality of recipient depository institutions, comprising a balance of funds held in each of the aggregated deposit accounts, wherein funds from one or a plurality of client accounts are aggregated with funds of other client accounts in the aggregated deposit accounts; and/or (ii) client account information for each of a plurality of deposit accounts comprising at least a respective balance of funds from the respective client account held in each of one or more recipient depository institutions in the aggregated deposit accounts holding funds of the respective client account.

In some embodiments, the invention relates to using one or more computers, one or more electronic databases, stored on one or more computer-readable media that comprises: one or a plurality of proposals for a public-space improvement projects (PIPs). In some embodiments, the invention relates to using one or more computers, one or more electronic databases, stored on one or more computer-readable media that comprises one or a plurality of aggregated deposit accounts, each aggregated deposit accounts corresponding to the one or a plurality of proposals for PIPs held in one or a plurality of recipient depository institutions, comprising a balance of funds held in each of the aggregated deposit accounts, wherein funds from one or a plurality of client accounts are aggregated with funds of other client accounts in the aggregated deposit accounts. In some embodiments, the invention relates to using one or more computers, one or more electronic databases, stored on one or more computer-readable media that comprises: client account information for each of a plurality of deposit accounts.

In some embodiments, any of the disclosed systems of the present invention comprise any of the disclosed computer program products disclosed herein and at least one aggregated deposit account corresponding to the one or a plurality of proposals for PIPs held in one or a plurality of recipient depository institutions. in some embodiments, the computer-implemented methods disclosed herein comprise accessing a website that performs any one or a combination of any of the disclosed steps through at least one processor. in some embodiments, the contributor, DGO, VC, RSP, or service provider access the website through connection to the internet using one or a plurality of computers operably linked by one or more data storage units.

The invention further provides a method of implementing public policy comprising performing any one or plurality of steps disclosed herein in combination and further comprising a designated government official assessing the progress of one or a plurality of PIPs, wherein, if the DGO approves of completion of the PIP, funds from a client account or aggregated deposit account are distributed to one or a plurality of service providers or RSPs who at least partially performed the one or plurality of PIPs.

The invention relates to a method comprising any one or plurality of steps disclosed herein. The invention also relates to a computer program product or a system comprising a computer program product disclosed herein wherein the computer program product comprises instructions for any one or plurality of steps disclosed herein performed through at least one computer processor.

### EXAMPLES

### Example 1

The method comprises a fund qualified as a charitable foundation and a website that permits a proponent-contributor (PC) or a registered service provider (RSP) to post a description of a public-space improvement project (PIP) in a location specified on a map displayed on the website. To post a PIP, the PC must commit funds from amounts the PC has previously contributed to the foundation (which amounts are held in the foundation under the name of the contributor until the funds are committed to a PIP).

After a PIP is proposed, other visitors to the website may commit additional funds from their own deposit accounts to the PIP. Contributions by visitor-contributors (VCs) may be contingent on such terms as may be specified by the VC or on modifications to the project description (which modifications must be accepted by the PC in order to take effect).

PIP commitments may not be withdrawn for a specified period or unless the PIP description is modified. The default non-withdrawal period is 90 days but a different period may be specified by the PC by entering such different period in a box provided on the website. In the event of any modification to the PIP description, existing VCs may withdraw their contributions for 72 hours following acceptance of the modification by the PC.

Once a PIP has been posted, a registered service provider (RSP) or service provider may post a bid indicating the price at which the RSP will perform the work. A bid may be contingent on modifications to the project description (which modifications must be accepted by the PC in order to take effect and which triggers VC withdrawal rights as with any other modification).

A PIP becomes a binding contract when funds equal to the price specified by the RSP have been committed to the PIP and the PIP has been approved by a designated government officer (DGO) (because of the need for permission to perform work in and on public spaces). A bid may be withdrawn at any time until it becomes a binding contract.

When work is finished, the RSP must so certify by checking a box on the website, which notifies the PC and all VCs by email that the project has been completed. Within seven days after such notification, the PC must certify that the project has been completed also by checking a box on the website, which notifies all VCs by email that the PC has approved the work. Within three days after such notification, VCs must post any objections to certification of completion. In the absence of objections, the RSP will be paid the agreed amount from the foundation by electronic transfer of funds. If the PC declines to certify or if any VC posts an objection to payment (setting forth specific factual grounds for any such objection), the matter will be referred to the DGO for resolution.

If no binding contract is formed, funds will be automatically returned to contributor accounts upon expiration of the non-withdrawal period. If excess funds are committed, PC and VC commitments will be prorated and the excess returned to individual accounts.

When a PIP is proposed, the website will drop a color-coded pin on a map appearing on the website, which pin specifies the location of the PIP and the nature and status of the work to be done (as to whether the PIP is in the funding stage or is funded with work proceeding or is completed with payment pending or is completed with payment made). The website also displays a running total of the amounts committed to the PIP as well as the low RSP bid (if any). Parties may also opt to be sent an email when any new commitment or bid is posted. The website also permits the posting of pictures relating to the project.

The website permits RSPs to post a PIP without making a contribution (either to the foundation or from the foundation to the project). But a RSP may offer to contribute to the project (including contributions of goods or services of stated value). RSP bids may also include provision for down-payments (to cover materials) and progress payments. RSPs whose bids require down-payments must be approved by the DGO as eligible therefor. Progress payments are subject to the same procedures as relate to completion payments (as discussed above).

RSPs that propose PIPs retain a right of first refusal to meet or beat a price proposed by a competing RSP. In the case of RSP-proposed PIPs, the first contributor may serve as PC but may decline to do so. If so, the right to serve as PC will be offered to subsequent contributors in the order in which they have posted commitments to the PIP.

Anyone may register with the website as a contributor by making a minimum contribution of $100 to the foundation which contribution is tax-deductible at the time of the contribution (because the foundation itself is a charitable foundation). Contributions to the foundation may not be withdrawn from the foundation because of the associated tax benefit. It is also possible to visit the website without already having set up an account and to make a one-time contribution to a PIP. But if the PIP does not ultimately get funded, the contribution reverts to an account in the name of the contributor for future use and cannot be refunded in cash (again because of the associated tax benefits).

Service providers may register with the website only after approval by the DGO under rules to be promulgated by the DGO as consistent with local law. It is the responsibility of the RSP to obtain all licenses and permits that would ordinarily be required in connection with the work to be done.

All postings are routed to the DGO who thus may monitor for the possibility of PIPs that are duplicative of projects already planned or funded by a government agency. The DGO may also propose specifications and modifications to PIPs in order to comply with existing law and regulations. Such specifications and modifications do not trigger withdrawal rights unless the DGO deems them to be material to the spirit of the project. If so, the DGO must check a box that notifies all contributors of their right to withdraw contributions for 72 hours after such notification.

### Example 2

In some embodiments, the system also comprises rules by which a PC may withdraw and be replaced by a VC, as well as rules relating to modification and abandonment of PIPs and rules relating to the disposition of dormant foundation contributions.

### Example 3

In some embodiments, any disclosed computer-implemented method comprises qualifying for and receiving a tax deduction upon depositing, distributing, or transfer of funds to one or a plurality of client accounts or aggregated deposit accounts.

### Example 4

In some embodiments, any disclosed computer-implemented method comprises notifying one or a plurality of designated government officials after one or a plurality of distribution criteria are met or fulfilled corresponding to one or a plurality of PIPs. In some embodiments, any disclosed computer-implemented method further comprises a designated government official reviewing a pending PIP for duplication prior to approving a PIP for at least partial performance.

1. A method comprising accessing, using one or more computers, one or more electronic databases, stored on one or more computer-readable media, for assisting in carrying out one or more of the following operations, the one or more databases comprising:
proposing one or a plurality of public space improvement projects (PIPs);
submitting bids to complete the one or plurality of PIPs;
depositing funds into the one or a plurality of client accounts;
designating funds deposited in the one or plurality of client accounts for aggregation into one or a plurality of aggregated deposit accounts;
accepting a bid to form a contractual relationship between an individual or group that submits a bid to complete the one or a plurality of PIPs;
authorizing the completion of the one or plurality of PIPs;
allocating funds from one or a plurality of client accounts to one or plurality of aggregated deposit accounts, each aggregated deposit account designated for one or a plurality of PIPs;
distributing funds from the one or plurality of aggregated deposit accounts that correspond to the one or a plurality of proposals for PIPs after a designated government official (DGO) authorizes the completion of the one or plurality of PIPs.

2. The method of claim 1, wherein the step of submitting a bid to complete the one or plurality of PIPs is performed, at least partially, through an online auction of one or a plurality of registered service providers (RSPs).

3. The method of claim 2, wherein the one or plurality of service providers are registered to complete one or more actions to complete the one or plurality of PIPs by a DGO responsible for a geographic area in which the one or plurality of PIPs is to be performed.

4. The method of claim 1, wherein, if the method comprises designating the funds deposited in the one or plurality of client accounts for aggregation into the one or a plurality of aggregated deposit accounts, the step of designating the funds for aggregation further comprises establishing one or a set of distribution criteria of how or when the funds must be distributed if the funds are approved for distribution.

5. The method of claim 1, wherein, if the method comprises submitting a bid to complete the one or plurality of PIPs, the step of submitting a bid to complete the one or plurality of PIPs further comprises establishing one or a set of distribution criteria of how or when the funds must be distributed if the funds are approved for distribution.

6. The method of claim 1, wherein, if the method comprises proposing one or a plurality of PIPs, the step of proposing one or a plurality of PIPs further comprises establishing one or a set of distribution criteria of how or when the funds must be distributed if the funds are approved for distribution.

7. The method of claim 1, wherein, if the method comprises proposing one or a plurality of PIPs, a first individual, group or entity or a first plurality of individuals, groups and entities proposes one or a plurality of PIPs and the method further comprises a second individual, group or entity or a plurality of individuals, groups or entities proposing one or a set of distribution criteria of how and/or when funds are distributed if the funds are approved for distribution.

8. The method of claim 7, wherein the set of distribution criteria comprise a price to complete one or a set of tasks for completion of the one or plurality of PIPs.

9. A method of aggregating charitable funds through one or more computers or one or more electronic databases, stored on one or more computer-readable media, the one or more databases comprising:
(i) one or a plurality of deposit accounts, each deposit accounts corresponding to the one or plurality of proposals for PIPs held in one or a plurality of recipient depository institutions; and
(ii) client account information corresponding to each of one or a plurality of deposit accounts;
obtaining one or a plurality of proposals for PIPs, each PIP comprising one or a plurality of distribution criteria;
obtaining at least a first and second balance of funds in the one or plurality of deposit accounts designated for the one or a plurality of PIPs, each of the balance of funds is obtained from different individuals, groups, or entities; and
allocating the at least first and second balances of funds into a single deposit account if one or a plurality of distribution criteria are met.

10. The method of claim 9, wherein the method further comprises receiving a bid to complete the one or plurality of PIPs from a service provider prior to allocating the at least first or second balance of funds into a single deposit account.

11. The method of claim 9, wherein the method further comprises receiving authorization from a designated government official (DGO) prior to allocating the at least first or second balance of funds into an a single deposit account.

12. The method of claim 9, wherein the method further comprises designating the funds deposited in the one or plurality of client accounts for aggregation into the one or a plurality of aggregated deposit accounts prior to allocating the at least first or second balance of funds into an a single deposit account.

13. The method of claim 10, wherein the method further comprises forming a contract between at least one individual, group or entity that contributes a balance of funds for performance of one or more PIPs and the registered service provider (RSP) when one or a plurality of distribution criteria are met.

14. The method of claim 9, wherein the one or plurality of distribution criteria comprises a proposed price to complete the one or plurality of PIPs.

15. A method of performing an online auction comprising:
obtaining one or a plurality of proposals for PIPs, each PIP comprising one or a plurality of distribution criteria;
obtaining at least a first balance of funds in one or plurality of deposit accounts designated for the one or a plurality of PIPs, the at least first balance of funds is obtained from at least a first individual, group, or entity; and
receiving one or a plurality of bids to complete the one or plurality of PIPs from one or a plurality of service providers;
allocating the at least first balance of funds for distribution to one or a plurality of service providers if the one or a plurality of distribution criteria are met.

16. The method of claim 15, wherein the step of allocating the at least first balance of funds comprises allocating, and optionally distributing, the at least first balance of funds into a single deposit account designated for at least partial performance of the one or plurality of PIPs.

17. The method of claim 15, wherein the method further comprises receiving authorization from a DGO if one or a plurality of distribution criteria are met.

18. The method of claim 15, wherein the method further comprises designating the funds deposited in the one or plurality of client accounts for aggregation into the one or a plurality of aggregated deposit accounts prior to allocating the at least first balance of funds.

19. The method of claim 10, wherein the method further comprises forming a contract between at least one individual, group or entity that contributes at least a first balance of funds for at least partial performance of one or more PIPs and the RSP when one or a plurality of distribution criteria are met.

20. The method of claim 10, wherein the one or plurality of distribution criteria comprises a target price to complete the one or plurality of PIPs.

21. The method of claim 10, wherein the one or plurality of distribution criteria comprises receiving authorization from a DGO.

22. A computer program product encoded on a computer-readable storage medium comprising instructions for:
obtaining one or a plurality of proposals for PIPs, each PIP comprising one or a plurality of distribution criteria;
obtaining at least a first balance of funds in one or a plurality of deposit accounts designated for the one or a plurality of PIN, the at least first balance of funds is obtained from at least a first individual, group, or entity; and
receiving one or a plurality of bids to complete the one or plurality of PIPs from one or a plurality of service providers; and
allocating the at least first balance of funds for distribution to one or a plurality of service providers if the one or a plurality of distribution criteria are met.

23. The computer program product of claim 22, wherein the computer-readable storage medium further comprises instruction for: allocating, and optionally distributing, the at least first balance of funds into a single deposit account designated for at least partial performance of the one or a plurality of PIPs.

24. The computer program product of claim 22, wherein the computer-readable storage medium further comprises instruction for: aggregating, and optionally distributing, the at least first balance of funds with at least a second balance of funds into a single deposit account designated for at least partial performance of the one or plurality of PIPs.

25. The computer program product of claim 22, wherein the computer-readable storage medium further comprises instruction for: receiving authorization from a DGO if one or a plurality of distribution criteria are met.

26. The computer program product of claim 22, wherein the computer-readable storage medium further comprises instruction for: designating the funds deposited in the one or a plurality of client accounts for aggregation into the one or a plurality of aggregated deposit accounts if one or a plurality of distribution criteria are met.

27. The computer program product of claim 22, wherein the computer-readable storage medium further comprises instruction for: forming a contract between at least one individual, group or entity that contributes at least a first balance of funds for at least partial performance of one or more PIPs and the RSP if one or a plurality of distribution criteria are met.

28. The computer program product of claim 22, wherein the one or plurality of distribution criteria comprises a target price to complete the one or plurality of PIPs.

29. The computer program product of claim 22, wherein the one or plurality of distribution criteria comprises receiving authorization from a DGO.

30. A system comprising the computer program product of claim 22.
